(19) United States
(12) Patent Application Publication
(10) Pub. No.: US 2010/0052536 A1
(43) Pub. Date: Mar. 4, 2010

(54) AMBIENT LED LIGHTING SYSTEM AND METHOD

(75) Inventors: Mark Andre Zielinski, Bloomfield Hills, MI (US); Karl William Wojcik, Sterling Heights, MI (US); Robert Andrew Miller, Plymouth, MI (US); James Martin Lawlis, Grosse Pointe Farms, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/204,416

(22) Filed: Sep. 4, 2008

(51) Int. Cl. B60Q 1/00

(52) U.S. Cl. 315/77

(57) ABSTRACT

An ambient lighting system in a vehicle is provided. The system comprises a lighting module and a central controller. The lighting module is configured for electrical connection to the vehicle and for driving at least one light emitting diode (LED) arrangement to display a desired ambient color and intensity. The central controller is configured to transmit a roll call command on a data communication bus to the lighting module to determine whether the lighting module is electrically connected to the vehicle.

### BACKGROUND OF THE INVENTION

1. Field of the Invention

The embodiments of the present invention generally relate to ambient light emitting diode (LED) systems in a vehicle.

2. Background Art

Conventional automotive ambient lighting systems include a central controller that is electrically coupled to a plurality of LED lighting modules. The LED lighting modules may be positioned in various zones of the vehicle. Such zones may correspond to various interior and/or exterior positions of the vehicle. Each LED lighting module may include three or four different colored LEDs. Such colored LEDs include red, green, and blue (RGB). In some cases, white colored LEDs may be implemented along with the RGB LEDs.

The central controller includes a plurality of output drivers for driving the colored LEDs. The output drivers may generate pulse width modulated (PWM) signals and drive the colored LEDs at different PWM duty cycles to create different colors and intensities. For example, the central controller may drive the red, green, and blue LEDs with the same PWM duty cycle to produce white light. In yet another example, a purple color may be achieved by driving each of the red and blue LEDs at various PWM duty cycles. As noted above, some LED configurations may include a dedicated white colored LED as opposed to driving the red, green and blue colored LED arrangements at similar duty cycles to generate the color white. Current automotive ambient lighting systems generally couple a single wire between each output driver that is positioned in the central controller and each colored LED positioned in a lighting module. A ground or return circuit is generally coupled between the central controller and all of the LED lighting modules positioned in a particular zone of the vehicle. As such, each LED lighting module may be connected to the central controller via 4 or 5 circuits. The cost of the system is influenced by the cost of the electrical wires (e.g., cut leads) and any such wire splices needed to electrically couple the cut leads.

In general, the color and intensity of the colored LEDs may vary due to manufacturing tolerances. Such variations in color and intensity may be visible to the human eye. To assist in mitigating such variances, LED manufacturers may divide LEDs that are produced into color, intensity, and forward voltage bins. The high volume of LEDs needed for automotive ambient applications generally prohibit the option of ordering all LEDs from the same bin combination due to cost factors. Such a case is particularly true for tri-color LEDs where the RGB LEDs are packaged as a single LED component. The total number of combination color/intensity bins for an RGB LED is typically in the thousands (e.g., each of the three LEDs may have 15 different intensity bins and 4 or more color bins resulting in a plurality of color/intensity combinations).

The commonly implemented alternative is to use LEDs from a limited number of bins that will produce light with reasonably acceptable color and intensity. Such an alternative may work well for many colors, however, the color white (or other signature color) may be more challenging. The color white along with other signature colors may be a difficult color to produce with RGB LEDs since even small variations are easily visible to the human eye. A common solution to such a problem is to add the white colored LED (or other signature color) to each lighting module as discussed above. The white LEDs generally produce a consistent, high quality white light. The drawback is that the white colored LEDs adds cost to the system. Efforts at correcting LED variations are gaining more attention by vehicle manufacturers in light of the growing popularity of the various ambient lighting schemes.

### SUMMARY

In at least one embodiment, an ambient lighting system in a vehicle is provided. The system comprises a lighting module and a central controller. The lighting module is configured for electrical connection to the vehicle and for driving at least one light emitting diode (LED) arrangement to display a desired ambient color and intensity. The central controller is configured to transmit a roll call command on a data communication bus to the lighting module to determine whether the lighting module is electrically connected to the vehicle.

### BRIEF DESCRIPTION OF THE DRAWINGS

FIG. 1 depicts an ambient lighting system in accordance to one embodiment of the present invention; and

FIG. 2 depicts an ambient lighting system in accordance to another embodiment of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

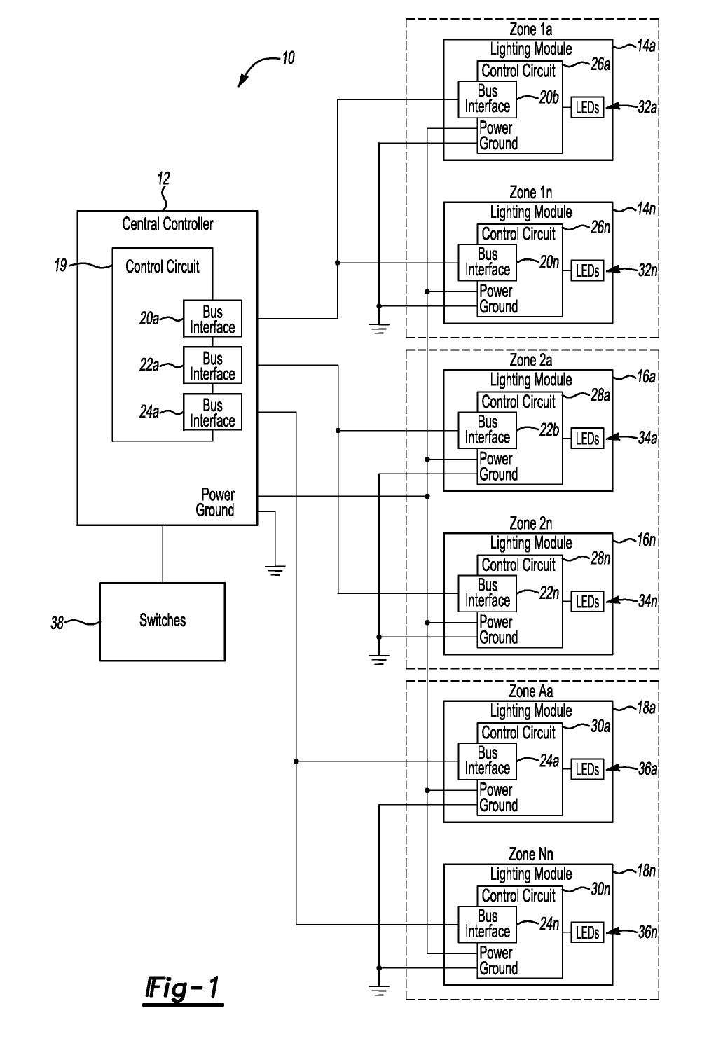

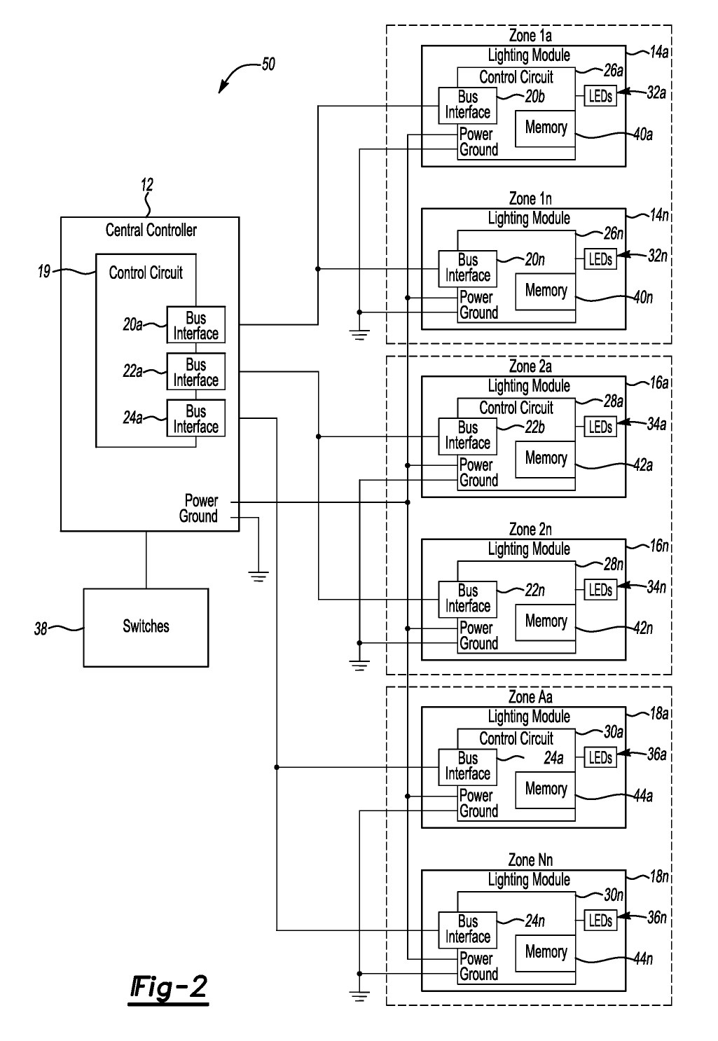

The embodiments of the present invention as set forth in FIGS. 1-2 generally illustrate and describe a plurality of controllers (or modules), or other such electrically based components for use in a ambient LED lighting system of a vehicle. All references to the various controllers and electrically based components and the functionality provided for each, are not intended to be limited to encompassing only what is illustrated and described herein. While particular labels may be assigned to the various controllers and/or electrical components disclosed, such labels are not intended to limit the scope of operation for the controllers and/or the electrical components. The controllers and/or modules may be combined with each other and/or separated in any manner based on the particular type of electrical architecture that is desired or intended to be implemented in the vehicle.

Referring now to FIG. 1, an ambient lighting system 10 of a vehicle in accordance to one embodiment of the present invention is shown. The system 10 includes a central controller 12 and a plurality of lighting modules 14a-14n, 16a-16n, and 18a-18n. The lighting modules 14a-14n, 16a-16n, and 18a-18n are positioned about various zones 1a-1n, 2a-2n, and Aa-Nn in the vehicle. One or more of the zones 1a-1n, 2a-2n, and Aa-Nn may be positioned within interior or about exterior portions of the vehicle. Such zones may correspond to a center console, an instrument panel, and/or an interior section of a vehicle door. The zones may include any section of the vehicle on which ambient lighting is capable of being positioned on. The lighting modules 14a-14n may be positioned in zones 1a-1n, the lighting modules 16a-16n may be positioned in zones 2a-2n, and the lighting modules 18a-18n may be positioned in zones Aa-Nn. The central controller 12 includes control circuit 19 and one or more bus interfaces 20a, 22a, and 24a. The control circuit 19 may include a microcontroller, Application Specific Integrated Circuit (ASIC) or other such circuit recognized to control a function or feature electronically.

The lighting modules 14a-14n, 16a-16n, and 18a-18n include a control circuit 26a-26n, 28a-28n, and 30a-30n, respectively. The control circuits 26a-26n, 28a-28n, and 30a-30n include a bus interface 20b-20n, 22b-22n, and 24b-24n, respectively. In general, the bus interfaces may facilitate bi-directional data communication between the central controller 12 and the lighting modules 14a-14n, 16a-16n, and 18a-18n via a local interconnect network (LIN) or other such data communication bus generally situated to facilitate data communication between controllers and/or modules in a vehicle. The particular type of data communication data bus implemented may vary based on the desired criteria of a particular implementation. The bus interface 20a is electrically coupled to the bus interfaces 20b and 20n to facilitate data communication between the central controller 12 and the lighting modules 14a-14n in zones 1a-1n. In a similar manner, the bus interface 22a is electrically coupled to the bus interfaces 22b-22n to facilitate data communication between the central controller 12 and the lighting modules 16a-16n in zones 2a-2n. Likewise, the bus interface 24a is electrically coupled to the bus interfaces 24b-24n to facilitate data communication between the central controller 12 and the lighting modules 18a-18n in zones Aa-Nn.

The lighting modules 14a-14n, 16a-16n, and 18a-18n include a LED arrangements 32a-32n, 34a-34n, and 36a-36n, respectively. The LED arrangements 32a-32n, 34a-34n, and 36a-36n may include 1-N LEDs. In one example, the LED arrangements 32a-32n, 34a-34n may include either three or four LED arrangements. As noted above, red, blue, and green LED arrangements may be controlled to provide the white color, or a dedicated white color LED may be added to provide the color white.

The central controller 12 may provide a power connection (e.g., POWER) for the lighting modules 14a-14n, 16a-16n, and 18a-18n located in the zones 1a-1n, 2a-2n, and Aa-Nn, respectively. It is generally contemplated that the power generated by the central controller 12 may include power conditioning circuitry (not shown) for conditioning the power supply and provide conditioned power to the lighting modules 14a-14n, 16a-16n, and 18a-18n. Switches 38 may be positioned about an instrument panel (or within a message center of an instrument cluster) and/or elsewhere in the vehicle for electrically communicating with the central controller 12 to allow occupants in the vehicle to select a desired ambient lighting color and intensity.

In operation, an occupant may select a desired color and intensity via the switches 38. The switches 38 transmit a light control signal to the central controller 12 which is generally indicative of the desired color and intensity for any particular zone 1a-in, 2a-2n, and Aa-Nn. The switches 38 may be implemented as hardwired based analog/digital switches or as touchscreen switches that are selectable via a user interface device which transmits digital data over a data communication bus to the central controller 12. In the event the switch 38 is coupled to another controller in the vehicle (e.g., not to the central control 12), such a controller may transmit the desired light and intensity from the switch 38 over a communication bus to the central controller 12. The control circuit 19 generates and transmits lighting control signals over any one or more of the bus interfaces 20a, 22a, and 24a that are indicative of the desired color and intensity selected by the occupant to one or more of the bus interfaces 20b, 20n, 22b, 22n, 24b, and 24n.

The lighting control signals are in the form of time coded digital data. The control circuit 19 may include one or more current drivers. In one example, the control circuit 19 may include up to three current drivers (not shown) that are each operably coupled to the bus interfaces 20a, 22a, and 24a for receiving and decoding the time coded digital data. Time coded digital data is generally comprised of voltages/current levels in which time is used as a reference such that the control circuits 26a-26n, 28a-28n, and 30a-30n use the time to determine when to sample the digital data for extracting data from the signal. The time coded digital data is generally considered asynchronous data in which a clock signal is not included within the time coded digital data. With such a case, the control circuits 26a-26n, 28a-28n, and 30a-30n may use the first falling edge of the time coded digital data as a time reference (or as a sample point) as to when data can be read to extract data. Such a first falling edge (or the sample point) as identified with respect to decoding time coded digital data may require that the control circuit 19 and the control circuits 26a-26n, 28a-28n, and 30a-30n have knowledge of and use the same baud rate as each other.

The lighting control signals generally correspond to the desired color and intensity selected by the occupant for a particular zone 1a-1n, 2a-2n, and Aa-Nn and are transmitted from any one or more of the bus interfaces 20a, 22a, and 24a.

The bus interfaces 20b-20n; 22b-22n; and/or 24b-24n receives the lighting control signals whereby the control circuits 26a-26n; 28a-28n; and/or 30a-30n decode the lighting control signals and drive the LED arrangements 32a-32n; 34a-34n; and 36a-36n via pulse width modulated (PWM) based signals to achieve the desired color and intensity. It is also contemplated that the control circuits 26a-26n, 28a-28n, and/or 30a-30n may include programmable current sources to drive the LED arrangements via current values.

Referring now to FIG. 2, an ambient lighting system 50 of a vehicle is shown in accordance to another embodiment of the present invention. The LED arrangements 32a-32n, 34a-34n, and 36a-36n may each include 1-N LED arrangements. For example, the LED arrangements 32a-32n, 34a-34n, and 36a-36n of zones 1a-1n, 2a-2n, and Aa-Nn may each include 3 LED arrangements (e.g., red, green, and blue) or 4 LED arrangements (e.g., red, green, blue, and white). The particular number of LED arrangements implemented may vary based on the desired criteria of a particular implementation. The control circuits 26a-26n, 28a-28n and 30a-30n generally include a memory (or EEPROM) 40a-40n, 42a-42n, and 44a-44n, respectively. The memories 40a-40n, 42a-42n, and 44a-44n may be utilized to store particular (or specific) PWM duty cycle values (or current values) related to generating desired uniform colors among the LED arrangements 32a-32n, 34a-34n, and 36a-36n. As noted above, due to variation, the LED arrangements 32a-32n, 34a-34n, and 36a-36n may generate dissimilar colors from one another even though the LED arrangements 32a-32n, 34a-34n, and 36a-36n may each include RGB LED arrangements. For example, if the LED arrangements 32a-32n, 34a-34n, and 36a-36n are controlled to generate a red color at a particular intensity, different shades and intensities of red may be visible to the occupant due to the variation inherent in LED binning. Such a condition may present an inconsistent red color appearance. To compensate for such an occurrence, the chromaticity coordinates for each LED arrangements 32a-32n, 34a-34n, and 36a-36n may be measured. A chroma meter (or spectroradiometer) may be used while the lighting modules 14a-14n, 16a-16n, and 18a-18n are being produced to measure the chromaticity coordinates of the light output from the LED arrangements 32a-32n, 34a-34n, and 36a-36n. In the event the measured chromaticity coordinates are not correct for a particular color, the intensity may be adjusted by driving the LED arrangements 32a-32n, 34a-34n, and 36a-36n at specific PWM duty cycles or at specific current values to obtain a desired uniform light output (e.g., drive the LED arrangements at different (or similar) PWM values or current values to achieve the desired uniform color output). The specific PWM duty cycles (or specific current values) that were established while the lighting modules 14a-14n, 16a-16n, and 18a-18n are being produced which adjusts color and the intensity accordingly may be stored in memory 40a-40n, 42a-42n, and 44a-44n for each desired color and intensity.

In the event the control circuits 26a-26n, 28a-28n, and 30a-30n drive the LED arrangements 32a-32n, 34a-34n, and 36a-36n with specific current values and/or PWM values and a user intends to dim the LED arrangements 32a-32n, 34a-34n, and 36a-36n; a linear switch (not shown) may be used to ramp down the current values to dim the color uniformly without exhibiting any color shift among the LED arrangements 32a-32n, 34a-34n, and 36a-36n. In the event the control circuits 26a-26n, 28a-28n, and 30a-30n drive the LED arrangement 32a-32n, 34a-34n, and 36a-36n with the specific PWM values and a user intends to dim the LED arrangements 32a-32n, 34a-34n, and 36a-36n, a switch that is used to dim the LED arrangements 32a-32n, 34a-34n, and 36a-36n may ramp down the PWM duty cycle. However, while in the process of ramping down the PWM duty cycle for the specific values, a color shift may occur that may be noticeable among the LED arrangement 32a-32n, 34a-34n, and 36a-36n as the PWM duty cycle ramps the specific PWM values down to zero.

The implementation of the memories 40a-40n, 42a-42n, and 44a-44n and the specific PWM values (or specific current values) may facilitate the use of lower priced LED arrangements. As noted above, the LED arrangements 32a-32n, 34a-34n, and 36a-36n may include only RGB. Because the memories 40a-40n, 42a-42n, and 44a-44n are capable of storing specific PWM duty cycle values (or specific current values) which assist in achieving a desired uniform color, the lighting modules 14a-14n, 16a-16n, and 18a-18n are capable of storing specific PWM duty cycle values (or current values) to combine the LED arrangements 32a-32n, 34a-34n, and 36a-36n accordingly to provide a desired uniform white color.

The system 50 may employ a roll call process to address manufacturing concerns related to connecting the lighting modules 14a-14n, 16a-16n, and 18a-18n in the vehicle during vehicle assembly. The roll call process may identify whether an operator in a vehicle assembly plant connected all of the lighting modules 14a-14n, 16a-16n, and 18a-18n to the proper wiring connections for a particular vehicle during vehicle assembly. For example, during vehicle start up at the assembly plant and while the vehicle is undergoing end-of-line testing, the central controller 12 may issue a roll call command over the bus interfaces 20a, 22a, and 24a to the bus interfaces 20b-20n, 22b-22n, and 24b-24n to request the lighting modules 14a-14n, 16a-16n, and 18a-18n to send a roll call response message back to the central controller 12. The roll call response messages may correspond to the number of lighting modules 14a-14n, 16a-16n and 18a-18n that are properly connected to the vehicle. The roll call message may also include information related to which zone the particular lighting module is located within. The central controller 12 use such information to determine which zone in the vehicle includes a lighting module that is not properly connected to the vehicle.

The central controller 12 may calculate the number of lighting modules 14a-14n, 16a-16n, and 18a-18n detected in the vehicle in response to receiving the roll call response messages from the lighting modules within the zones 1a-1n, 2a-2n, and Aa-Nn. The central controller 12 may compare the total number of detected lighting modules 14a-14n, 16a-16n, and 18a-18n to a predetermined lighting module count value to determine if one or more of the lighting modules 14a-14n, 16a-16n, and 18a-18n in the vehicle have been properly connected. In the event the total number of connected lighting modules 14a-14n, 16a-16n, and 18a-18n does not equal the predetermined lighting module count value, the central controller 12 may set a diagnostic trouble code (DTC) to indicate that the appropriate number of lighting modules 14a-14n, 16a-16n, and 18a-18n have not been connected. In such a case, the central controller 12 also includes memory (not shown) for storing the predetermined lighting module count value. The predetermined lighting module count value may be stored in the memory of the central controller 12 prior to being shipped to the assembly plant. The DTCs set by the central controller 12 may also indicate the particular lighting module that is not properly connected for trouble shooting purposes. The central controller 12 may include a look up table comprising predetermined zone information for comparison to the zone information received on the roll call response messages to identify which zone includes a lighting module that is not properly connected.

In another example, the predetermined lighting module count value may be written into the memory of the central controller 12 via diagnostic equipment at the assembly plant. Such a condition takes into account that multiple vehicle platforms may be built at the assembly plant and that different lighting module count values that correspond to different vehicle platforms may be downloaded into the central controller 12 without the need to have a separate central controller 12 for a given vehicle platform. The central controller 12 may transmit the roll call command while the vehicle is out in the field and utilized in normal driving operation. The central controller 12 may transmit the roll call message to determine whether the lighting modules 14a-14n, 16a-16n, and 18a-18n are properly connected while the vehicle is driven in its normal drive cycle. For example, the central controller 12 may transmit the roll call command after each key ignition cycle (e.g., engine start-up) or at predetermined intervals of normal vehicle operation.

The system 50 is also configured to determine whether any one or more of the LED arrangements 32a-32n, 34a-34n, and 36a-36n is properly connected to the lighting modules 14a-14n, 16a-16n, and 18a-18n. In the event one or more of the LED arrangements 32a-32n, 34a-34n and/or 36a-36n for corresponding lighting modules 14a-14n, 16a-16n, and 18a-18n is not properly connected, the affected lighting module 14a-14n, 16a-16n, and 18a-18n may transmit a message to the central controller 12 so that the central controller 12 may set a DTC to indicate which zone 1a-1n, 2a-2n and Aa-Nn includes a LED arrangement 32a-32n, 34a-34n and/or 36a-36n that is not properly connected. Such lighting modules 14a-14n, 16a-16n, and 18a-18n may also be configured to set and store the DTCs. A technician or dealer may couple a diagnostic tool to the central controller 12 and/or the lighting modules 14a-14n, 16a-16n, and 18a-18n to read the DTCs.

The lighting modules 14a-14n, 16a-16n, and 18a-18n may also be configured to determine whether any one or more of the LED arrangements 32a-32n, 34a-34n, and 36a-36n are in an open or short state. For example, the control circuits 26a-26n, 28a-28n, and 30a-30n may measure the amount of current that is being used by the LED arrangements 32a-32n, 34a-34n, and 36a-36n to determine if the LED arrangements 32a-32n, 34a-34n, and 36a-36n are experiencing short or open conditions. In general, the control circuits 26a-26n, 28a-28n, and 30a-30n may intermittently measure current through the LED arrangements 32a-32n, 34a-34n, and 36a-36n while the ambient lighting system 50 is in its normal operating mode. The control circuits 26a-26n, 28a-28n, and 30a-30n may also measure current through the LED arrangements 32a-32n, 34a-34n, and 36a-36n in response to a command issued by a diagnostic tool over the bus or to a command issued by the central controller 12. In the event the control circuits 26a-26n, 28a-28n, and 30a-30n detect that at any one LED (e.g., red, blue, green, or white) within a particular LED arrangement 32a-32n, 34a-34n, and 36a-36n experience a short or open condition, the control circuits 26a-26n, 28a-28n, and 30a-30n may transmit a DTC over the bus to the central controller 12 or to a diagnostic tool to report which particular LED within the particular LED arrangement 26a-26n, 28a-28n, and 30a-30n is experiencing the short or open condition. It is also generally contemplated that each lighting module 14a-14n, 16a-16n, and/or 18a-18n may each store any such DTCs and report such DTCs directly to the diagnostic tool instead of transmitting such codes to the central controller 12.

While embodiments of the present invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An ambient lighting system in a vehicle, the system comprising:
a lighting module configured for electrical connection to the vehicle and for driving at least one light emitting diode (LED) arrangement to display a desired ambient color and intensity; and
a central controller configured to transmit a roll call command on a data communication bus to the lighting module to determine whether the lighting module is electrically connected to the vehicle.

2. The system of claim 1 wherein the lighting module is further configured to transmit a roll call response message to the central controller on the data communication bus in response to the roll call command to indicate that the lighting module is properly electrically connected to the vehicle.

3. The system of claim 2 wherein the central controller is further configured to set and store one or more diagnostic trouble codes in response to failing to receive the roll call response message from the lighting module.

4. The system of claim 1 wherein the lighting module is further configured to measure an amount of current used to drive the at least one LED arrangement to determine the presence of a LED failure for a particular LED within the at least one LED arrangement.

5. The system of claim 1 wherein the lighting module is further configured to measure an amount of current used to drive the at least one LED arrangement to determine whether a particular LED within the at least one LED arrangement is experiencing a short circuit condition.

6. The system of claim 1 wherein the lighting module is further configured to measure an amount of current used to drive the at least one LED arrangement to determine whether a particular LED within the at least one LED arrangement is experiencing an open condition.

7. The system of claim 4 wherein the lighting module is further configured to set one or more diagnostic trouble codes in response to detecting the presence of the LED failure.

8. An ambient lighting system in a vehicle, the system comprising:
a plurality of lighting modules disposed within the vehicle and each configured to drive at least one light emitting diode (LED) arrangement to display a desired ambient color and intensity and to generate a roll call response message indicative of whether the lighting module is electrically connected to the vehicle, and
a central controller configured to:
determine the number of electrically connected lighting modules in response to the roll call response messages;
compare the number of electrically connected lighting modules to a predetermined lighting module count value, and
determine the presence of an electrical connection error for at least one lighting module of the plurality of lighting modules based on the comparison of the number of electrically connected lighting modules to the at least one predetermined lighting module count value.

9. The system of claim 8 wherein the central controller is further configured to set and store one or more diagnostic trouble codes (DTCs) in response to determining that the number of properly electrically connected lighting modules is not equal to the predetermined lighting module count value.

10. The system of claim 8 wherein each lighting module is further configured to measure an amount of current used to drive the at least one LED arrangement to determine the presence of a LED failure for a particular LED within the at least one LED arrangement.

11. The system of claim 8 wherein each lighting module is further configured to measure an amount of current used to drive the at least one LED arrangement to determine whether a particular LED within the at least one LED arrangement is experiencing a short circuit condition.

12. The system of claim 8 wherein each lighting module is further configured to measure an amount of current used to drive the at least one LED arrangement to determine whether a particular LED within the at least one LED arrangement is experiencing an open condition.

13. The system of claim 10 wherein each lighting module is further configured to set and store one or more diagnostic trouble codes (DTCs) in response to detecting the presence of an LED failure.

14. An ambient lighting system in a vehicle, the system comprising:
a plurality of lighting modules disposed within zones of the vehicle and each configured to generate a roll call response message indicative of whether the lighting module is electrically connected to the vehicle in response to a roll call command and to drive at least one light emitting diode (LED) arrangement to display a desired ambient color and intensity, and
a central controller configured to:
generate the roll call command;
determine the number of electrically connected lighting modules in response to the roll call response messages;
compare the number of electrically connected lighting modules to a predetermined lighting module count value; and
determine the presence of an electrical connection error for at least one lighting module of the plurality of lighting modules based on the comparison of the number of electrically connected lighting modules to the at least one predetermined lighting module count value.

15. The system of claim 14 wherein the lighting module is further configured to transmit a roll call response message to the central controller on the data communication bus in response to the roll call command to indicate that the lighting module is properly electrically connected to the vehicle.

16. The system of claim 15 wherein the central controller is further configured to set and store one or more diagnostic trouble codes in response to failing to receive the roll call response message from the lighting module.

17. The system of claim 14 wherein the lighting module is further configured to measure an amount of current used to drive the at least one LED arrangement to determine the presence of a LED failure for a particular LED within the at least one LED arrangement.

18. The system of claim 14 wherein the lighting module is further configured to measure an amount of current used to drive the at least one LED arrangement to determine whether a particular LED within the at least one LED arrangement is experiencing a short circuit condition.

19. The system of claim 14 wherein the lighting module is further configured to measure an amount of current used to drive the at least one LED arrangement to determine whether a particular LED within the at least one LED arrangement is experiencing an open condition.

20. The system of claim 14 wherein the roll call response message includes zone information to identify the particular zone in which the lighting module is located and the central controller is further configured to determine the particular zone in which the lighting module is not properly connected based on the roll call response message.
